(19) United States
(12) Patent Application Publication
(10) Pub. No.: US 2024/0208075 A1
(43) Pub. Date: Jun. 27, 2024

(54) SENSOR UNIT AND ROBOT HAND

(71) Applicant: SINTOKOGIO, LTD., Nagoya-shi (JP)

(72) Inventors: Yoshikane TANAAMI, Nagoya-shi (JP); Miyuki HAYASHI, Nagoya-shi (JP)

(73) Assignee: SINTOKOGIO, LTD., Nagoya-shi (JP)

(21) Appl. No.: 18/493,134

(22) Filed: Oct. 24, 2023

(30) Foreign Application Priority Data
Dec. 26, 2022 (JP) 2022-208869

(51) Int. Cl. B25J 13/08; B25J 15/10

(52) U.S. Cl. CPC B25J 13/082; B25J 15/103

(57) ABSTRACT

Provided is a technique that makes it possible both to protect a gripping target object that is gripped by a gripping part of a robot hand, and to further increase accuracy of detection by a sensor. A sensor unit includes: a diaphragm that is provided in a gripping part of a robot hand; and a sensor unit that detects an external force while being provided in the diaphragm. The diaphragm has a film that is capable of adjusting resistance to displacement, and the sensor is provided in the film.

This Nonprovisional application claims priority under 35 U.S.C. § 119 on Patent Application No. 2022-208869 filed in Japan on Dec. 26, 2022, the entire contents of which are hereby incorporated by reference.

### TECHNICAL FIELD

The present invention relates to a sensor unit and a robot hand.

### BACKGROUND ART

In inspection or sorting of products, a target object is sometimes determined by touching a product with a human hand. It is being considered to carry out, by a robot hand, a work thus carried out by a human hand. For example, as a technique for detecting contents of a gripping target object that is gripped with use of a robot hand, a technique is known in which a gripping target object is gripped by a robot hand including a sensor that detects a vibration of a gripping part, and contents of the gripping target object are determined in accordance with a detection signal that indicates a low-frequency vibration which is detected when the gripping target object is swung. In the technique, in order to prevent slipping from occurring when the gripping target object is gripped by the gripping part, and to protect the gripping target object, such as to prevent the gripping target object from being scratched, when the gripping target object is gripped by the gripping part, a buffer member is disposed in a part of the gripping part which part is in contact with the gripping target object (for example, see Patent Literature 1).

### CITATION LIST

### Patent Literature

[Patent Literature 1]

Japanese Patent Application Publication Tokukai No. 2021-094639

### SUMMARY OF INVENTION

### Technical Problem

According to such a conventional technique as described above, a state of a gripping target object is detected by a sensor via a buffer member and further via a gripping part. Thus, the conventional technique still has room for consideration in terms of making it possible both to protect a gripping target object that is gripped by a gripping part of a robot hand, and to further increase accuracy of detection by a sensor.

An aspect of the present invention has an object to provide a technique that makes it possible both to protect a gripping target object that is gripped by a gripping part of a robot hand, and to further increase accuracy of detection by a sensor.

### Solution to Problem

In order to attain the object, a sensor unit in accordance with an aspect of the present invention includes: a diaphragm that has a film which is capable of adjusting resistance to displacement and that is attachable to a gripping part of a robot hand; and a sensor that is attached to the film and that detects an external force on a detection surface thereof.

In order to attain the object, a robot hand in accordance with an aspect of the present invention includes: a gripping part that grips a gripping target object; and a sensor unit described above.

### Advantageous Effects of Invention

An aspect of the present invention makes it possible both to protect a gripping target object that is gripped by a gripping part of a robot hand, and to further increase accuracy of detection by a sensor.

### BRIEF DESCRIPTION OF DRAWINGS

FIG. 1 is a view schematically illustrating a configuration of a robot hand in accordance with an embodiment of the present invention.

FIG. 2 is an enlarged view schematically illustrating a configuration of an A part of FIG. 1.

FIG. 3 is a view for describing how a gripping target object is gripped by the robot hand of FIG. 1 and how an external force is detected by a sensor.

### DESCRIPTION OF EMBODIMENTS

The following description specifically discusses an embodiment of the present invention.

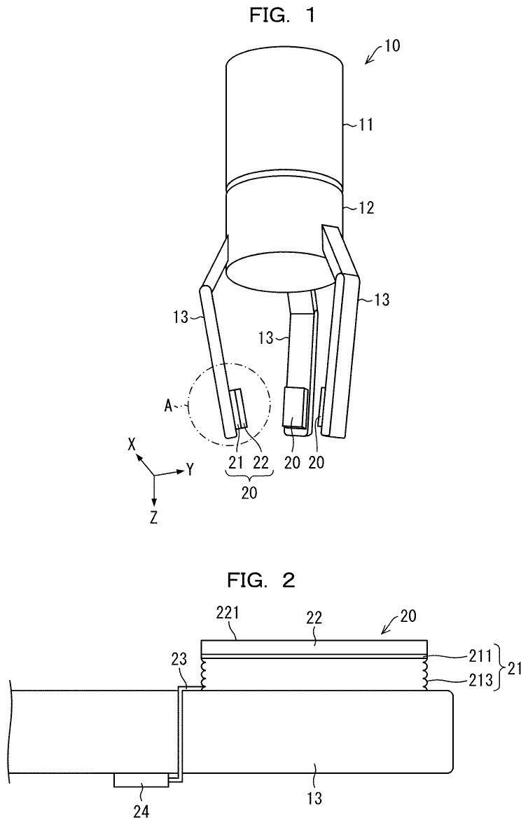

FIG. 1 is a view schematically illustrating a configuration of a robot hand in accordance with an embodiment of the present invention. The robot 10 illustrated in FIG. 1 includes a robot arm 11, a robot hand 12 that is connected to a tip side of the robot arm 11, and gripping parts 13 that are connected to a tip side of the robot hand 12. In the present embodiment, a vertical direction is regarded as a Z direction, and two directions orthogonal to the Z direction are defined as an X direction and a Y direction. The X direction and the Y direction are directions orthogonal to each other.

The robot hand 12 has the gripping parts 13 and sensor units 20. The gripping parts 13 are configured in the robot 10 to grip a gripping target object. The number of the gripping parts 13 are three. The gripping parts 13 are disposed in an XY plane at three locations that are at equal distances from a central axis of the robot arm 11 and that are at regular intervals in a circumferential direction of the robot hand 12. The three gripping parts 13 are configured to grip the gripping target object, for example, by operating so as to approach each other or be spaced apart from each other with respect to the central axis in an XY plane direction.

The sensor units 20 each include a diaphragm 21 and a sensor 22. The sensor units 20 are attached to respective tip parts of the gripping parts 13. FIG. 2 is an enlarged view schematically illustrating a configuration of an A part of FIG. 1.

The diaphragm 21 includes a film 211. The film 211 is supported on a gripping part 13 in a state in which the diaphragm 21 is attached to the gripping part 13. A configuration of the diaphragm 21 will be described later.

The sensor 22 is attached to the film 211. The sensor 22 has, on an opposite side from a side of the sensor 22 on which side the film 211 is attached, a detection surface 221 that detects an external force. Thus, the sensor 22 is attached to the film 211 so as to detect an external force while being attached to the film 211. The sensor 22 is, for example, a contact-type sensor capable of detecting an external force. Examples of the sensor 22 include a capacitive sensor, a piezoelectric sensor, and a resistive film (wire-wound resistor) sensor. The sensor 22 is, for example, a capacitive tactile sensor, and is a sensor capable of detecting magnitude of an external force applied to the detection surface 221.

The diaphragm 21 is constituted by a circumferential wall part 213 that extends upward from the gripping part 13 and the film 211 that covers a top part of the circumferential wall part 213. The diaphragm 21 thus includes the circumferential wall part 213 that supports the film 211 in a peripheral edge part of the film 211. The circumferential wall part 213 has, along an entire circumference thereof, a bellows structure that is expandable and contractible in a height direction of the circumferential wall part 213. The bellows structure is expandable and contractible in a direction perpendicular to the detection surface 221 of the sensor 22. The circumferential wall part 213 thus has the bellows structure that is expandable and contractible in the direction perpendicular to the detection surface 221 of the sensor 22.

A space surrounded by the circumferential wall part 213 and the film 211 is filled with a liquid for pressure adjustment. The liquid can be selected as appropriate provided that an internal pressure of the diaphragm 21 can be properly set. The liquid preferably further has a stable physical property. Examples of such a liquid include aqueous media and oils. In the present embodiment, the diaphragm 21 is filled with oil for hydraulic adjustment.

The diaphragm 21 may be made of a flexible (deformable) material such as fluoro rubber, or may be made of a hard (non-deformable) material such as plastic or metal. For example, both the film 211 and the circumferential wall part 213 can be made of a flexible material, or can be made of a hard material. The film 211 and the circumferential wall part 213 may be made of either a flexible material or a hard material. A material of the diaphragm 21 can be selected as appropriate in accordance with various conditions such as a type and texture of the gripping target object, details of a work carried out by the robot 10, and an environment in which the robot 10 carries out the work. In order to prevent or reduce damage to the gripping target object that is gripped by the gripping part 13, the material of the diaphragm 21 is preferably a flexible material. In order to increase accuracy of detection by the sensor 22 when the gripping target object is gripped by the gripping part 13, the material of the diaphragm 21 is preferably a hard material.

The sensor unit 20 further includes a pressure transmitting pipe 23 and a hydraulic sensor 24. The pressure transmitting pipe 23 has one end that is connected to an internal space of the diaphragm 21, and is filled with oil in the diaphragm 21. The hydraulic sensor 24 is connected to the other end of the pressure transmitting pipe 23 and is a pressure sensor that detects a pressure of oil (hydraulic pressure) in the pressure transmitting pipe 23. Thus, the sensor unit 20 is configured such that a hydraulic pressure in the diaphragm 21 can be detected by the hydraulic sensor 24 via the pressure transmitting pipe 23.

Note that the hydraulic pressure in the diaphragm 21 is set as appropriate by, for example, filling a specific amount of oil from the pressure transmitting pipe 23 into the diaphragm 21, and sealing the internal space of the diaphragm 21 and the pressure transmitting pipe 23 with respect to outside. Alternatively, the hydraulic pressure in the diaphragm 21 is set as appropriate by detecting a hydraulic pressure during filling of oil into the diaphragm 21, and sealing the internal space of the diaphragm 21 and the pressure transmitting pipe 23 with respect to outside at a time point when the detected hydraulic pressure reaches a specific hydraulic pressure. Oil can be filled into the pressure transmitting pipe 23 by, for example, filling oil via a three-way valve (not illustrated) that is interposed in the pressure transmitting pipe 23. The hydraulic pressure in the pressure transmitting pipe 23 is adjustable by, for example, a position of a piston that is capable of advancing and retracting in a cylinder which is connected to a system for hermetically sealing the oil. The hydraulic pressure in the diaphragm 21 is thus adjusted to a specific pressure.

The hydraulic pressure in the diaphragm 21 is set as appropriate in accordance with (i) a physical property of the gripping target object that is to be gripped by the gripping part 13 and (ii) the details of the work carried out by the robot 10. For example, in a case where the gripping target object is a soft article and the work carried out by the robot 10 is selection of a non-defective product, the hydraulic pressure is set to a moderate pressure that when the gripping part 13 grips the gripping target object via the sensor unit 20, prevents the sensor 22 from causing damage to the gripping target object.

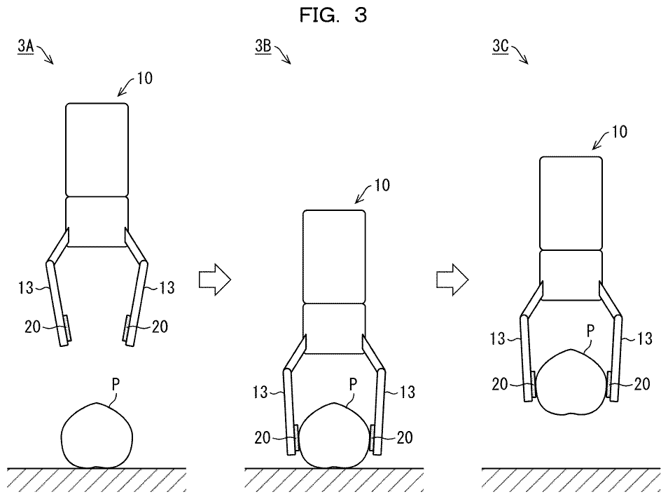

FIG. 3 is a view for describing how the gripping target object is gripped by the robot hand 12 of FIG. 1 and how an external force is detected by the sensor 22. In FIG. 3, “3A” illustrates a state before a gripping target object P is gripped, “3B” illustrates a state immediately after the gripping target object P has been gripped, and “3C” illustrates a state in which the gripping target object P is gripped and handled.

The gripping target object P is disposed in a working area of the robot 10. For example, the gripping target object P may be conveyed to the working area of the robot 10 by a conveying device such as a conveyance belt, or the robot 10 may move to a position of the gripping target object P (3A).

The robot 10 opens the gripping parts 13, approaches the gripping target object P, causes the gripping parts 13 to sandwich the gripping target object P, and comes into contact with both side parts of the gripping target object P (3B).

The robot 10 holds the gripping target object P that is sandwiched by the gripping parts 13, and moves the gripping target object P upward. The gripping target object P is thus gripped by the gripping parts 13 of the robot 10 (3C).

Since the sensor 22 is attached to the diaphragm 21 via the film 211, a force from the gripping target object P that is gripped by the gripping parts 13 is detected by the sensor 22.

In the diaphragm 21, the film 211 is supported by the circumferential wall part 213 that has the bellows structure.

This enables the film 211 to advance and retract in the height direction of the circumferential wall part 213 while the gripping target object P is being gripped by the gripping parts 13. Furthermore, the film 211 can be tilted along a surface of the gripping target object P, or in accordance with a direction in which an external force is applied to the detection surface 221 of the sensor 22. The film 211 is also capable of advancing and retracting in the height direction of the circumferential wall part 213 while remaining tilted or being tilted freely.

The robot 10 grips the gripping target object P with a predetermined gripping force. The hydraulic pressure in the diaphragm 21 is adjusted to a proper hydraulic pressure in advance in accordance with the physical property of the gripping target object P. Thus, in a case where the gripping target object P is gripped by the gripping parts 13, an excess force out of forces with which the gripping parts 13 grip the gripping target object P is partially absorbed by deformation of the diaphragm 21. This prevents or reduces damage that is caused by gripping by the gripping parts 13 to the gripping target object P. With a suitable inclination in accordance with a shape of the gripping target object P, the detection surface 221 of the sensor 22 is in contact with the gripping target object P. This enables the sensor 22 to detect, with high accuracy, a force applied by the gripping target object P.

### Embodiment in Which Control Section Refers to Hydraulic Pressure

In an initial phase in which the gripping parts 13 grip the gripping target object P with a specific gripping force, (3B in FIG. 3), oil vibrates minutely in response to the gripping parts 13 having come into contact, via the diaphragm 21, with the gripping target object P. In order to minimize an influence of a measurement error, caused by such vibration, on control, a control section for the robot hand 12 refers to a result of detection by the hydraulic sensor 24 and determines a force from the gripping target object P (a force acting on the sensor 22 from the gripping target object P).

For example, in 3B of FIG. 3, the control section for the robot hand 12 determines, as the force from the gripping target object P, a detection value of the sensor 22 which detection value is obtained after a fluctuation of a detection value of the hydraulic sensor 24 is settled to a certain range of numerical values (more specifically, after an amplitude of the fluctuation falls below a predetermined threshold value). Thus, the influence of the measurement error, caused by the fluctuation, on the control can be minimized by disregarding the detection value of the sensor 22 which detection value is obtained before the fluctuation of the detection value of the hydraulic sensor 24 is settled to a certain range of numerical values.

The control section for the robot hand 12 can also use the detection value of the hydraulic sensor 24 to control a gripping force of the robot hand 12. For example, at a moment when the gripping parts 13 lift the gripping target object P with a specific gripping force, or while the gripping parts 13 are gripping the gripping target object P (3C in FIG. 3), the gripping force may be insufficient or a posture of the gripping target object P may change so as to cause a part of the gripping target object P which part is in contact with the detection surface 221 of the sensor 22 to move along the detection surface 221 (i.e., slip). Such slipping causes oil vibrations. In such a case, a control section for the robot 10 adjusts the gripping force of the robot hand 12 with reference to the result of detection by the hydraulic sensor 24.

For example, upon detecting the fluctuation of the detection value of the hydraulic sensor 24 (for example, a fluctuation having an amplitude that exceeds the predetermined threshold value) while the gripping parts 13 are gripping and handling the gripping target object P, the control section for the robot hand 12 controls the robot hand 12 so that the gripping target object P is gripped with a higher force. For example, the robot hand 12 is controlled so that the gripping force with which the gripping target object P is gripped increases by a predetermined increase. The control section for the robot hand 12 repeatedly carries out such an operation until the fluctuation of the detection value of the hydraulic sensor 24 is settled to a certain range of numerical values (for example, until the amplitude of the fluctuation falls below the predetermined threshold value). Thus, the gripping target object P is gripped by the gripping parts 13 with a more appropriate strength, so that slipping does not occur. In the present embodiment, the gripping force of the robot hand 12 is thus adjusted to a more appropriate gripping force on the basis of the detection value of the hydraulic sensor 24.

A specific increase in gripping force is set as appropriate in accordance with the physical property of the gripping target object P and the details of the work carried out by the robot 10. For example, in a case where the gripping target object P is an article that is soft and easily deformed, such as fruit, the specific increase is set to a value that is so small to an extent that a further amount of displacement (amount of movement) of the gripping parts 13 with respect to the gripping target object P does not substantially affect a state of the surface of the gripping target object P.

The sensor unit 20 includes the diaphragm 21 that is attachable to the gripping part 13 of the robot hand 12, and the sensor 22 that is attached to the film 211 of the diaphragm 21. The sensor 22 detects an external force on the detection surface 221 while being attached to the film 211. The sensor unit 20 is thus configured such that the sensor 22 can detect an external force in a state in which a buffering effect brought about by the diaphragm 21 is achieved. Thus, the buffering effect brought about by the diaphragm 21 is already sufficiently exhibited in a state in which the detection surface 221 of the sensor 22 is in contact with the surface of the gripping target object P, that is, in a state in which the detection surface detects an external force. Thus, during detection of an external force, in order not to damage the surface of the gripping target object P, the detection surface 221 of the sensor 22 comes into contact with the gripping target object P, and the sensor 22 that is in contact with the gripping target object P detects an external force from the gripping target object P.

The film 211 is displaced in the direction perpendicular to the detection surface 221. Therefore, while the gripping target object P is being gripped by the gripping parts 13, the buffering effect brought about by the diaphragm 21 is easily sufficiently exhibited. The sensor unit 20 is thus advantageous in order to prevent, by a sufficient buffering effect brought about by the diaphragm 21, damage to the gripping target object P that is being gripped.

The diaphragm 21 includes the circumferential wall part 213 that supports the film 211 in the peripheral edge part of the film 211. The circumferential wall part 213 has the bellows structure that is expandable and contractible in the direction perpendicular to the detection surface 221 of the sensor 22. The circumferential wall part 213 of the bellows structure can be tilted not only in the direction perpendicular to the detection surface 221 but also in a direction oblique to the detection surface 221 so as to face in that direction, and is expandable and contractible while being inclined so as to face in the direction oblique to the detection surface 221. The above configuration makes it easy to orient the detection surface 221 in a direction in which the detection surface 221 is in contact with the gripping target object P, and is advantageous in order to (i) prevent the gripping target object P from being damaged by gripping and (ii) detect, with high accuracy, an external force from the gripping target object P. The sensor units 20 thus makes it possible both to protect the gripping target object P that is gripped by the gripping parts 13 of the robot hand 12, and to further increase accuracy of detection by the sensor 22.

The space surrounded by the circumferential wall part 213 and the film 211 is filled with oil. A pressure of the oil (hydraulic pressure) is adjusted. Thus, adjustment of the pressure of the oil is suitable so that a moderate resistance force in accordance with the gripping target object P and the details of the work carried out by the robot 10 is exhibited with respect to displacement of the film 211 of the diaphragm 21. The fact that a filling material is the oil is also suitable because the oil makes it possible to sufficiently detect slipping of the gripping target object P and because the oil is physically and chemically sufficiently stable.

The sensor unit 20 further includes a control section together with the hydraulic sensor 24, the control section controlling the robot hand 12, upon detection of a vibration of oil by the hydraulic sensor 24, so that the gripping target object P is gripped with a higher gripping force. The sensor unit 20 that further includes the control section is advantageous in order to achieve gripping with a minimum necessary gripping force.

### Another Aspect of Control Section

The functions of the control section can be realized by a program for causing a computer to function so that the foregoing example of control in accordance with a detection value of a hydraulic sensor is carried out. For example, the computer includes at least one control device (e.g., a processor) and at least one storage device (e.g., a memory). The foregoing control by the control section is realized by the program being executed by the at least one control device and the at least one storage device.

The program may be recorded in one or more non-transitory computer-readable recording media. The recording media may be included in the computer or need not be included in the computer. In the latter case, the program may be supplied to the computer via any wired or wireless transmission medium.

Furthermore, some or all of the control by the control section can also be realized by a logic circuit. For example, the control can also be realized by an integrated circuit in which a logic circuit that realizes the control is provided. In addition, the control can also be realized by, for example, a quantum computer.

Furthermore, processes in one or both of (i) control in accordance with a detection result of the hydraulic sensor 24 and (ii) control in accordance with a detection result of the sensor 22 in the foregoing embodiment may be carried out by artificial intelligence (AI). For example, AI may be trained with use of training data in which the detection value of the sensor 22 and the detection value of the hydraulic sensor 24 are used as input values. For example, AI may learn, from the detection value of the sensor 22 and the detection value of the hydraulic sensor 24, an appropriate gripping force for each gripping target object P. In this case, AI may be operated in the control device, or may be operated in another device (e.g., an edge computer or a cloud server).

### Variation

Minute vibrations of the oil at the beginning of gripping will soon stop. Thus, instead of reference to the detection value of the hydraulic pressure by the control section, the detection value of the sensor 22 may be determined as a measurement value of the sensor 22, the detection value being obtained after a specific period of time sufficient for the foregoing vibrations of the oil to stop has passed since the gripping target object P was gripped by the gripping parts 13. Such a standby time can be specified by an experiment carried out with use of an actual machine. Such an aspect also makes it possible to obtain an accurate detection value of the sensor 22.

In the environment in which the robot 10 carries out the work, in a case where a state of the gripping target object P is observed by capture of an image, slipping of the gripping target object P that is being gripped may be detected on the basis of the captured image.

The robot hand 12 may have less than three gripping parts 13, for example, two gripping parts 13, or have more than three gripping parts 13, for example, four or five gripping parts 13.

The above configuration makes it possible to more delicately grip a soft article such as high-quality fruit such as strawberries or peaches, as compared with a conventional configuration. Thus, a work equivalent to gripping of such an article by a human hand is expected to be carried out by a robot. The present invention is therefore expected to contribute to development of industrialization, for example, is expected to contribute to achievement of Goal 9 “Build resilient infrastructure, promote inclusive and sustainable industrialization and foster innovation” of Sustainable Development Goals (SDGs) proposed by the United Nations.

The present invention is not limited to the above embodiments, but can be altered in various ways within the scope of the claims. The present invention also encompasses, in its technical scope, any embodiment derived by appropriately combining technical means disclosed in differing embodiments.

1. A sensor unit comprising:
a diaphragm that has a film which is capable of adjusting resistance to displacement and that is attachable to a gripping part of a robot hand; and
a sensor that is attached to the film and that detects an external force on a detection surface thereof.

2. The sensor unit as set forth in claim 1, wherein the film is displaced in a direction perpendicular to the detection surface.

3. The sensor unit as set forth in claim 1, wherein
the diaphragm includes a circumferential wall part that supports the film in a peripheral edge part of the film, and
the circumferential wall part has a bellows structure that is expandable and contractible in the direction perpendicular to the detection surface of the sensor.

4. The sensor unit as set forth in claim 3, wherein a space surrounded by the circumferential wall part and the film is filled with oil, and a pressure of the oil is adjusted.

5. The sensor unit as set forth in claim 4, further comprising:
a hydraulic sensor that detects the pressure of the oil; and
a control section that controls the robot hand, upon detection of a vibration of the oil by the hydraulic sensor, so that a gripping target object is gripped with a higher gripping force.

6. A robot hand comprising:
a gripping part that grips a gripping target object; and
a sensor unit recited in claim 1.
